(19) United States
(12) Patent Application Publication
(10) Pub. No.: US 2025/0332832 A1
(43) Pub. Date: Oct. 30, 2025

(54) LIQUID EJECTING HEAD AND LIQUID EJECTING APPARATUS

(71) Applicant: SEIKO EPSON CORPORATION, Tokyo (JP)

(72) Inventor: Shingo TOMIMATSU, SHIOJIRI-SHI (JP)

(21) Appl. No.: 19/185,693

(22) Filed: Apr. 22, 2025

(30) Foreign Application Priority Data
Apr. 25, 2024 (JP) 2024-071243

(51) Int. Cl. B41J 2/14; B41J 2/16; B41J 2/19

(52) U.S. Cl. CPC B41J 2/14233; B41J 2/1433; B41J 2/1623; B41J 2/19; B41J 2002/14362

(57) ABSTRACT

A liquid ejecting head includes a head chip having a common liquid chamber that communicates with nozzles configured to eject a liquid in a first direction, and a flow path structure having a flow path that communicates with the common liquid chamber, in which the head chip has a flow path pipe that protrudes in a second direction opposite to the first direction from a surface facing the second direction and that has a coupling flow path communicating with the common liquid chamber inside, the flow path structure has an opening into which the flow path pipe is inserted, and the flow path and the coupling flow path are liquid-tightly coupled with an adhesive disposed between an outer peripheral surface of the flow path pipe and an inner peripheral surface of the opening.

The present application is based on, and claims priority from J P Application Serial Number 2024-071243, filed Apr. 25, 2024, the disclosure of which is hereby incorporated by reference herein in its entirety.

### BACKGROUND

### 1. Technical Field

The present disclosure relates to a liquid ejecting head and a liquid ejecting apparatus that discharge a liquid from nozzles, and particularly, to an ink jet recording head and an ink jet recording apparatus that eject ink as a liquid.

### 2. Related Art

A liquid ejecting apparatus represented by an ink jet recording apparatus, such as an ink jet printer or plotter, includes a liquid ejecting head that is capable of ejecting a liquid, such as ink stored in a cartridge, a tank or the like, as liquid droplets.

The liquid ejecting head includes a head chip having a nozzle for ejecting a liquid, a fixing plate to which the head chip is fixed, and a flow path structure having a holder for accommodating the head chip between the fixing plate and the flow path structure, and having a flow path for supplying the liquid to the head chip. The flow path of the flow path structure and the flow path of the head chip are liquid-tightly coupled by bonding the surfaces perpendicular to a stacking direction with an adhesive (see, for example, JP-A-2022-25894).

However, because the flow path structure and the head chip are bonded together with an adhesive at the surfaces perpendicular to the stacking direction, when the adhesive cures, the adhesive shrinks, causing the head chip to approach the flow path structure in the stacking direction, which may cause deformation such as denting of the fixing plate to which the head chip is fixed.

### SUMMARY

According to an aspect of the present disclosure, there is provided a liquid ejecting head including: a first head chip having a plurality of first nozzles that eject a liquid in a first direction and a first common liquid chamber that communicates with the plurality of first nozzles; a flow path structure having a first flow path that communicates with the first common liquid chamber; a fixing plate that accommodates the first head chip between the fixing plate and the flow path structure by fixing the first head chip to the fixing plate, and has a first exposure opening portion for exposing the plurality of first nozzles; and a first adhesive, in which the first head chip has a first flow path pipe that protrudes in a second direction opposite to the first direction from a surface facing the second direction and that has a first coupling flow path communicating with the first common liquid chamber inside, the flow path structure has a first opening that penetrates a portion of the flow path structure in the second direction from a surface facing the first direction and into which the first flow path pipe is inserted, and the first flow path and the first coupling flow path are liquid-tightly coupled with the first adhesive disposed between an outer peripheral surface of the first flow path pipe and an inner peripheral surface of the first opening.

According to another aspect of the present disclosure, there is provided a liquid ejecting head including: a first head chip having a plurality of first nozzles that eject a liquid in a first direction and a first common liquid chamber that communicates with the plurality of first nozzles; a flow path structure having a first flow path that communicates with the first common liquid chamber; a fixing plate that accommodates the first head chip between the fixing plate and the flow path structure by fixing the first head chip to the fixing plate, and has a first exposure opening portion for exposing the plurality of first nozzles; and a first adhesive, in which the flow path structure has a first flow path pipe that protrudes in the first direction from a surface facing the first direction and that has a first coupling flow path which is a portion of the first flow path, inside, the first head chip has a first opening that penetrates a portion of the first head chip in the first direction from a surface facing a second direction opposite to the first direction and into which the first flow path pipe is inserted, and the first common liquid chamber and the first coupling flow path are liquid-tightly coupled with the first adhesive disposed between an outer peripheral surface of the first flow path pipe and an inner peripheral surface of the first opening.

According to still another aspect of the present disclosure, there is provided a liquid ejecting apparatus including: the liquid ejecting head according to the above aspect; and a liquid storage portion that stores a liquid to be supplied to the liquid ejecting head.

### BRIEF DESCRIPTION OF THE DRAWINGS

FIG. 1 is a diagram showing a schematic configuration of a liquid ejecting apparatus according to a first embodiment.

FIG. 2 is an exploded perspective view of a liquid ejecting head according to the first embodiment.

FIG. 3 is a cross-sectional view of the liquid ejecting head according to the first embodiment.

FIG. 4 is an enlarged cross-sectional view of a main portion of the liquid ejecting head according to the first embodiment.

FIG. 5 is a cross-sectional view of a head chip according to the first embodiment.

FIG. 6 is a view showing a first flow path coupling portion and an adhesive according to the first embodiment as viewed in a +Z direction.

FIG. 7 is an enlarged cross-sectional view of a main portion of the liquid ejecting head according to the first embodiment.

FIG. 8 is a cross-sectional view showing a modification example of the head chip according to the first embodiment.

FIG. 9 is an enlarged cross-sectional view of a main portion of a modification example of the liquid ejecting head according to the first embodiment.

FIG. 10 is an enlarged cross-sectional view of a main portion of a liquid ejecting head according to a second embodiment.

FIG. 11 is an enlarged cross-sectional view of a main portion of a liquid ejecting head according to a third embodiment.

### DESCRIPTION OF EMBODIMENTS

The present disclosure will be described in detail below based on embodiments. However, the following description shows one embodiment of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of three spatial axes that do not limit the positive direction and the negative direction will be described as the X-axis direction, the Y-axis direction, and the Z-axis direction.

### First Embodiment

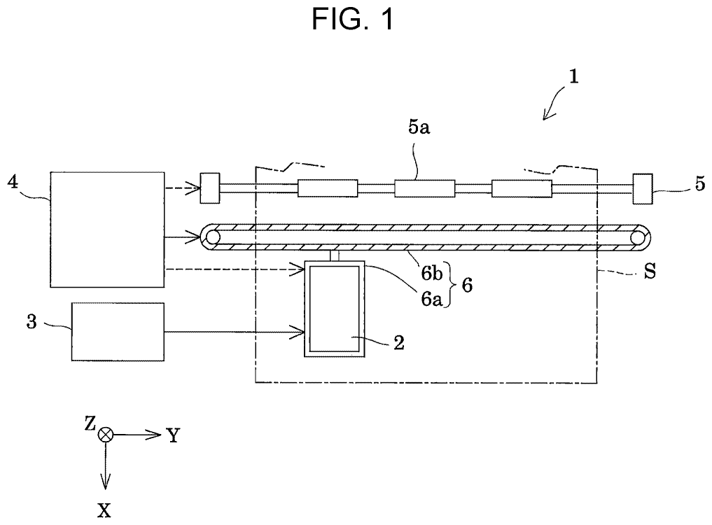

FIG. 1 is a diagram showing a schematic configuration of a liquid ejecting apparatus 1 according to the present disclosure.

As shown in the drawing, the liquid ejecting apparatus 1 is an ink jet recording apparatus that causes ink, which is one type of liquid, to be ejected and land on a medium S such as a printing paper sheet as ink droplets, and prints an image or the like based on an arrangement of dots formed at the medium S. As the medium S, in addition to recording paper, any material such as a resin film or cloth can be used.

The liquid ejecting apparatus 1 includes a liquid ejecting head 2, a liquid storage portion 3, a control unit 4 which is a control portion, a transport mechanism 5 that feeds out a medium S, and a moving mechanism 6.

The liquid ejecting head 2 ejects ink supplied from the liquid storage portion 3 from a plurality of nozzles in the +Z direction. The detailed configuration of the liquid ejecting head 2 will be described later.

The liquid storage portion 3 stores the ink ejected from the liquid ejecting head 2. Examples of the liquid storage portion 3 include a cartridge that is attachable and detachable to the liquid ejecting apparatus 1, a bag-shaped ink pack made of a flexible film, and an ink tank that can be replenished with ink. Note that, although not particularly shown, for example, a plurality of types of ink having different colors or components are individually stored in the liquid storage portion 3. Furthermore, the liquid storage portion 3 may be divided into a main tank and a sub-tank. The sub-tank may be coupled to the liquid ejecting head 2, and ink consumed by ejecting ink droplets from the liquid ejecting head 2 may be replenished from the main tank.

The control unit 4 includes, for example, a control device such as a central processing unit (CPU) or a field programmable gate array (FPGA), and a storage device such as a semiconductor memory. The control unit 4 totally controls each element of the liquid ejecting apparatus 1, that is, the liquid ejecting head 2, the transport mechanism 5, the moving mechanism 6, and the like by executing the program stored in the storage device by the control device.

The transport mechanism 5 transports the medium S in the X-axis direction, and has a transport roller 5a. That is, the transport mechanism 5 transports the medium S in the X-axis direction by rotating the transport roller 5a. The transport mechanism 5 that transports the medium S is not limited to the one including the transport roller 5a, and may transport the medium S by a belt or a drum, for example.

The moving mechanism 6 includes a transport body 6a and a transport belt 6b. The transport body 6a is a substantially box-shaped structure for accommodating the liquid ejecting head 2, a so-called carriage, and is fixed to the transport belt 6b. The transport belt 6b is an endless belt erected along the Y-axis direction. The transport belt 6b is rotated by the drive of a transport motor (not shown). The control unit 4 rotates the transport belt 6b by controlling the drive of the transport motor to reciprocate the liquid ejecting head 2 together with the transport body 6a in the Y-axis direction along a guide rail (not shown). The liquid storage portion 3 can also be mounted on the transport body 6a together with the liquid ejecting head 2.

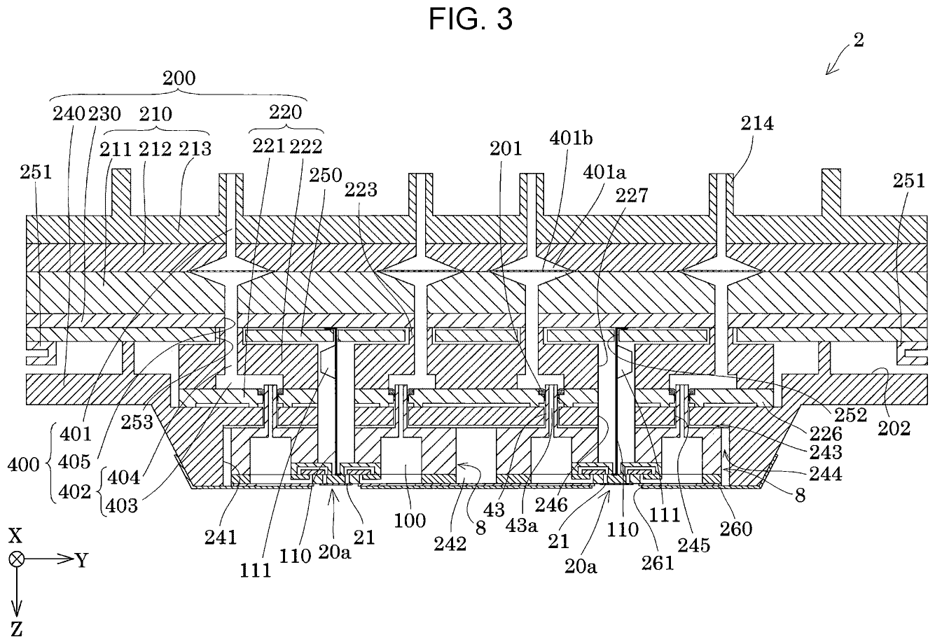

Under the control of the control unit 4, the liquid ejecting head 2 executes an ejection operation of ejecting the ink supplied from the liquid storage portion 3 in the +Z direction as ink droplets from each of a plurality of nozzles 21 (refer to FIG. 3). The ejection operation of ink droplets by the liquid ejecting head 2 is performed in parallel with the transport of the medium S by the transport mechanism 5 and the reciprocating movement of the liquid ejecting head 2 by the moving mechanism 6, and accordingly, an image is formed by ink on the surface of the medium S, that is, a so-called printing operation is performed.

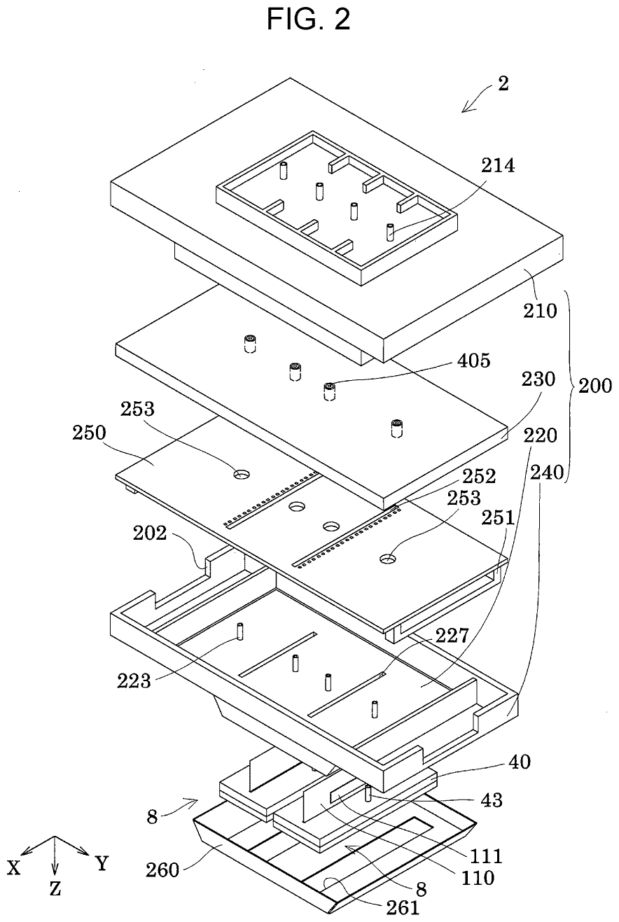

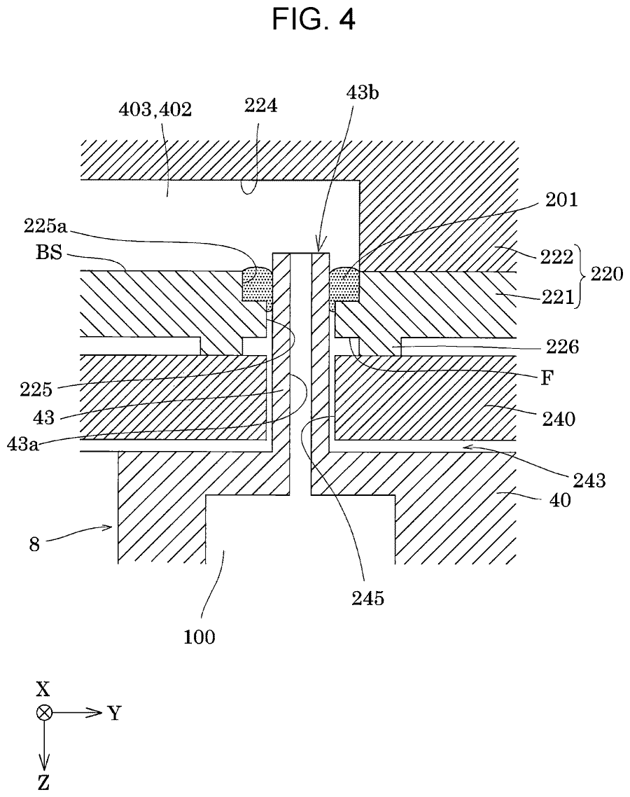

The liquid ejecting head 2 will be described with reference to FIGS. 2 to 4. FIG. 2 is an exploded perspective view of the liquid ejecting head 2. FIG. 3 is a cross-sectional view of the liquid ejecting head 2. FIG. 4 is an enlarged cross-sectional view of the main portion of FIG. 3. Each direction of the liquid ejecting head 2 will be described based on the directions when mounted on the liquid ejecting apparatus 1, that is, the X-axis direction, the Y-axis direction, and the Z-axis direction. Naturally, the position of the liquid ejecting head 2 in the liquid ejecting apparatus 1 is not limited to those shown below.

As shown in the drawing, the liquid ejecting head 2 includes a head chip 8, a flow path member 200 having a flow path 400, a relay substrate 250, and a fixing plate 260.

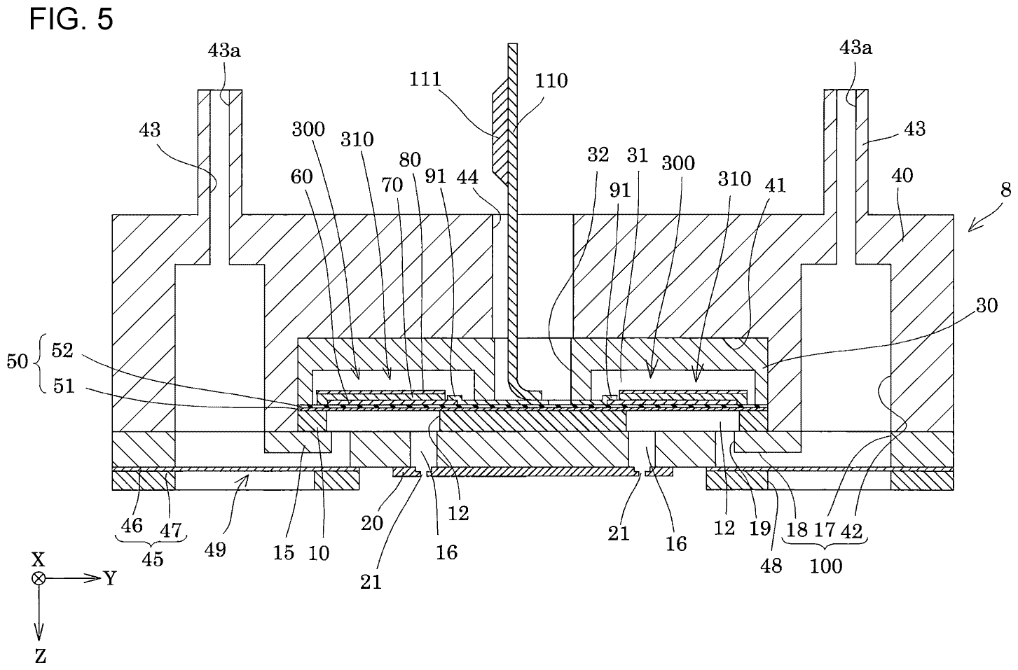

First, an example of the head chip 8 of the present embodiment will be described. FIG. 5 is a cross-sectional view of the head chip 8. Note that the directions of the head chip 8 will be described based on the directions when it is mounted on the liquid ejecting head 2, that is, the X-axis direction, the Y-axis direction, and the Z-axis direction.

As shown in the drawing, the head chip 8 includes a flow path forming substrate 10, a communication plate 15, a nozzle plate 20 having a plurality of nozzles 21 formed therein, a protective substrate 30, a case member 40, and a piezoelectric actuator 300.

The flow path forming substrate 10 is made of, for example, a silicon substrate. On the flow path forming substrate 10, a plurality of pressure chambers 12 are disposed side by side along the X-axis direction. The plurality of pressure chambers 12 are disposed on a straight line along the X-axis direction such that positions in the Y-axis direction are the same. In the present embodiment, two pressure chamber rows, in which the pressure chambers 12 are arranged side by side along the X-axis direction, are provided in the Y-axis direction. The pressure chambers 12 constituting these two pressure chamber rows are disposed at the same position in the X-axis direction. The two pressure chamber rows may be disposed to be shifted from each other in the X-axis direction by half the pitch of the pressure chambers 12, that is, by a so-called half pitch. In other words, all the pressure chambers 12 in the two pressure chamber rows may be disposed in a staggered manner along the X-axis direction.

The communication plate 15 and the nozzle plate 20 are sequentially stacked on the surface of the flow path forming substrate 10 facing the +Z direction. A vibration plate 50 and the piezoelectric actuator 300 are sequentially stacked on the surface of the flow path forming substrate 10 facing the −Z direction.

The communication plate 15 is formed of a plate-shaped member bonded to the surface of the flow path forming substrate 10 facing the +Z direction. The communication plate 15 is provided with a nozzle communication passage 16 that makes the pressure chamber 12 and the nozzle 21 communicate with each other. The communication plate 15 is provided with a first common liquid chamber portion 17 and a second common liquid chamber portion 18 that constitute a portion of a common liquid chamber 100 through which the plurality of pressure chambers 12 communicate in common. The first common liquid chamber portion 17 is provided to penetrate the communication plate 15 in the Z-axis direction. Further, the second common liquid chamber portion 18 is provided to be open on the surface facing the +Z direction without penetrating the communication plate 15 in the Z-axis direction. Furthermore, the communication plate 15 is provided with a supply communication passage 19 that communicates with the pressure chamber 12 independently for each pressure chamber 12. Each of a plurality of supply communication passages 19 causes the second common liquid chamber portion 18 and each of the plurality of pressure chambers 12 to communicate with each other, and supplies the ink in the common liquid chamber 100 to each of the pressure chambers 12. Such a communication plate 15 is made of, for example, a silicon substrate.

The nozzle plate 20 is bonded to the side of the communication plate 15 opposite to the flow path forming substrate 10, that is, to the surface facing the +Z direction. The nozzle plate 20 has a plurality of nozzles 21 formed therein, which communicate with each of the pressure chambers 12 through the nozzle communication passage 16. In the present embodiment, the plurality of nozzles 21 are disposed side by side in a row along the X-axis direction for each pressure chamber row. That is, in the present embodiment, two nozzle rows, in which the nozzles 21 are arranged side by side along the X-axis direction, are provided spaced apart in the Y-axis direction. The nozzles 21 constituting the two nozzle rows are disposed to be at the same position in the X-axis direction. Of course, when the two pressure chamber rows are disposed at positions shifted from each other by half the pitch of the pressure chambers 12 in the X-axis direction, the two nozzle rows may also be similarly disposed at positions shifted from each other by half the pitch of the nozzles 21 in the X-axis direction. In other words, all of the nozzles 21 in the two nozzle rows may be disposed in a staggered manner along the X-axis direction.

Such a nozzle plate 20 is made of, for example, a silicon substrate. The surface of the nozzle plate 20 facing the +Z direction is referred to as a nozzle surface 20a.

In the present embodiment, the vibration plate 50 has, for example, an elastic film 51 made of silicon oxide provided on the surface of the flow path forming substrate 10 facing the −Z direction, and an insulator film 52 made of zirconium oxide provided on the surface of the elastic film 51 facing the −Z direction. The vibration plate 50 may be composed of only the elastic film 51, or may be composed of only the insulator film 52, or may have another film in addition to the elastic film 51 and the insulator film 52.

The piezoelectric actuator 300 includes a first electrode 60, a piezoelectric layer 70, and a second electrode 80 that are sequentially stacked on the vibration plate 50 in the −Z direction. Such a piezoelectric actuator 300 is also called a piezoelectric element, and refers to a portion including the first electrode 60, the piezoelectric layer 70, and the second electrode 80. In addition, a portion where piezoelectric strain occurs in the piezoelectric layer 70 when a voltage is applied between the first electrode 60 and the second electrode 80 is referred to as an active portion 310. That is, the active portion 310 refers to a portion where the piezoelectric layer 70 is interposed between the first electrode 60 and the second electrode 80. In the present embodiment, the active portion 310 is formed for each pressure chamber 12. The plurality of active portions 310 serve as “drive elements” that cause pressure changes in the ink inside the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is separated for each active portion 310 to form an individual electrode of the active portion 310, and the second electrode 80 is continuously provided over the plurality of active portions 310 to form a common electrode for the plurality of active portions 310. The first electrode 60 may form a common electrode, and the second electrode 80 may form an individual electrode.

The piezoelectric layer 70 is configured, for example, using a piezoelectric material made of a perovskite structure composite oxide represented by the general formula ABO₃.

Further, an individual lead electrode 91 serving as a lead-out wiring is pulled out from the first electrode 60. Furthermore, a common lead electrode (not shown) serving as a lead-out wiring is pulled out from the second electrode 80. A wiring substrate 110 having flexibility is coupled to the end portions of these individual lead electrode 91 and common lead electrode opposite to the end portions coupled to the piezoelectric actuator 300. The wiring substrate 110 is mounted with a drive circuit 111 having a plurality of switching elements that select whether or not to supply a drive signal (COM) for driving each of the active portions 310 to each of the active portions 310. In other words, the wiring substrate 110 in the present embodiment is a chip-on-film (COF). The wiring substrate 110 may not be provided with the drive circuit 111. In other words, the wiring substrate 110 may be a flexible flat cable (FFC), flexible printed circuits (FPCs), and the like.

The protective substrate 30 having substantially the same size as the flow path forming substrate 10 is bonded to the surface of the flow path forming substrate 10 facing the −Z direction. The protective substrate 30 has a piezoelectric actuator accommodation portion 31 which is a space for protecting the piezoelectric actuator 300. The piezoelectric actuator accommodation portion 31 is independently provided for each row of the piezoelectric actuators 300 disposed side by side in the X-axis direction, and two piezoelectric actuator accommodation portions 31 are formed side by side in the Y-axis direction. A through hole 32 penetrating in the Z-axis direction is provided between two piezoelectric actuator accommodation portions 31 disposed side by side in the Y-axis direction, in the protective substrate 30. The end portions of the individual lead electrode 91 and a common lead electrode (not shown) pulled out from electrodes of the piezoelectric actuator 300 extend to be exposed within the through hole 32, and the individual lead electrode 91 and the common lead electrode are electrically coupled to the wiring substrate 110 within the through hole 32. Such a protective substrate 30 is made of, for example, a silicon substrate, similarly to the flow path forming substrate 10.

In addition, the case member 40 that defines a portion of the common liquid chamber 100 that communicates with the plurality of pressure chambers 12 is fixed onto the protective substrate 30. The case member 40 has substantially the same shape as the communication plate 15 described above in a plan view, and is bonded to the protective substrate 30 and also bonded to the communication plate 15 described above. Such a case member 40 has a recess portion 41 having a depth for accommodating the flow path forming substrate 10 and the protective substrate 30 on the protective substrate 30 side. The case member 40 is also provided with a third common liquid chamber portion 42 that communicates with the first common liquid chamber portion 17 of the communication plate 15. The first common liquid chamber portion 17 and the second common liquid chamber portion 18 provided in the communication plate 15 and the third common liquid chamber portion 42 provided in the case member 40 constitute the common liquid chamber 100 of the present embodiment. The common liquid chamber 100 is provided for each nozzle row. In other words, different types of ink can be ejected from each nozzle row.

The case member 40 also has a first flow path coupling portion 43 that is coupled to the flow path member 200. The first flow path coupling portion 43 is provided on the surface of the case member 40 facing the −Z direction, and protrudes in a tubular shape in the −Z direction. In the present embodiment, the first flow path coupling portion 43 has a circular outer peripheral surface, that is, a circular tube shape, when viewed in the Z-axis direction. Of course, the first flow path coupling portion 43 is not limited to a circular tube shape, and may be a tubular shape whose outer peripheral surface is rectangular when viewed in the Z-axis direction. However, as will be described in detail later, when the first flow path coupling portion 43 has a circular tube shape, stresses due to curing and shrinkage of an adhesive 201 act from all directions along the XY plane and are more likely to be cancelled out by each other.

At least the first flow path coupling portion 43 of the case member 40 is made of a rigid body. A rigid body refers to a member made of a material that does not have elasticity, and does not include a member made of a material that has elasticity, such as an elastomer, or a thin, deformable member such as a membrane.

Inside the first flow path coupling portion 43, a coupling flow path 43a that supplies ink from the flow path member 200 to the common liquid chamber 100 is provided. In the present embodiment, one first flow path coupling portion 43 is provided for each common liquid chamber 100, that is, two first flow path coupling portions 43 in total. Of course, the number of first flow path coupling portions 43 is not particularly limited thereto, and two or more first flow path coupling portions 43 may be provided for one common liquid chamber 100.

In addition, the case member 40 has a wiring coupling port 44 that communicates with the through hole 32 of the protective substrate 30 and through which the wiring substrate 110 is inserted, and the wiring substrate 110 is led out to the surface side of the liquid ejecting head 2 facing the −Z direction through the wiring coupling port 44. The case member 40 is made of, for example, a metal material or a resin material.

Further, a compliance substrate 45 is provided on the surface of the communication plate 15 on the +Z direction side where the first common liquid chamber portion 17 and the second common liquid chamber portion 18 open. The compliance substrate 45 seals the openings of the first common liquid chamber portion 17 and the second common liquid chamber portion 18 on the +Z direction side. In the present embodiment, such a compliance substrate 45 includes a sealing film 46 made of a flexible thin film, and a fixed substrate 47 made of a hard material such as metal. The region of the fixed substrate 47 facing the common liquid chamber 100 has an opening portion 48 that is completely removed in the thickness direction, and one side of the common liquid chamber 100 forms a compliance portion 49, which is a flexible portion sealed only by a flexible sealing film 46.

In such a liquid ejecting head 2, a liquid is taken in from the coupling flow path 43a, and the inside of the flow path from the common liquid chamber 100 to the nozzle 21 is filled with ink. Thereafter, in accordance with a signal from the drive circuit 111, a voltage is applied to each active portion 310 corresponding to the pressure chamber 12, thereby deflecting and deforming the vibration plate 50 together with the piezoelectric actuator 300. Accordingly, the pressure of the liquid in the pressure chamber 12 increases, and droplets are ejected from a predetermined nozzle 21 in the +Z direction.

The flow path member 200 has a flow path 400 that supplies a liquid from the liquid storage portion 3 to the head chip 8. In the present embodiment, four flow paths 400 are provided for each nozzle row, that is, for each common liquid chamber 100, independently of each other. Here, the term “independent flow paths” refers to flow paths that do not communicate with each other inside the liquid ejecting head 2. The flow paths 400 may be supplied with different types of ink or the same type of ink. Of course, the flow paths 400 are not limited to being provided independently of each other, and may be branched midway when the same type of liquid is ejected from two or more nozzle rows.

Such a flow path member 200 includes a first flow path member 210 having a first flow path portion 401 that constitutes the flow path 400, a second flow path member 220 having a second flow path portion 402 that constitutes the flow path 400, a seal member 230 that liquid-tightly couples the first flow path portion 401 and the second flow path portion 402, and a holder 240. The first flow path member 210, the seal member 230, the second flow path member 220, and the holder 240 are stacked in this order in the +Z direction.

In the present embodiment, the first flow path member 210 is configured by stacking three members 211, 212, and 213 in the Z-axis direction. The first flow path member 210 has a second flow path coupling portion 214 that is coupled to a liquid storage portion 3 that stores ink as a liquid. The second flow path coupling portion 214 in the present embodiment is provided on the surface of the first flow path member 210 facing the −Z direction, and protrudes in a tubular shape in the −Z direction. The liquid storage portion 3 is coupled to the second flow path coupling portion 214 through a tube or the like. Inside such a second flow path coupling portion 214, a portion of a first flow path portion 401 to which ink is supplied from the liquid storage portion 3 is provided.

The first flow path member 210 has a first flow path portion 401 that constitutes the flow path 400. The first flow path portion 401 is provided in the first flow path member 210 along the Z-axis direction. In addition, the first flow path portion 401 is not limited to being composed only of a flow path provided along the Z-axis direction, and may, for example, include a flow path inclined with respect to the Z-axis direction, or may include a flow path provided along the stacked interface of the three members 211, 212, and 213.

A filter chamber 401a having an inner diameter wider than other regions is provided in the middle of the first flow path portion 401, and a filter 401b is provided within the filter chamber 401a to capture foreign matter such as dust and air bubbles contained in the ink.

In the present embodiment, four first flow path portions 401 are provided independently in correspondence with the number of nozzle rows of the head chip 8, that is, the number of common liquid chambers 100. Of course, the number of first flow path portions 401 is not particularly limited thereto.

The second flow path member 220 is configured by stacking a first substrate 221 and a second substrate 222 in this order in the −Z direction. The first substrate 221 is made of a rigid body. In the present embodiment, the first substrate 221 and the second substrate 222 are made of resin, metal, or the like, and are both rigid bodies.

The second flow path member 220 has a third flow path coupling portion 223 that is coupled to the first flow path portion 401. The third flow path coupling portion 223 is provided on the surface of the first substrate 221 facing the −Z direction, and protrudes in a tubular shape in the −Z direction.

The second flow path member 220 is provided with a second flow path portion 402 that constitutes a portion of the flow path 400. The second flow path portion 402 includes a first portion 403 extending in a direction orthogonal to the Z-axis direction at the stacked interface between the first substrate 221 and the second substrate 222, and a second portion 404 provided along the Z-axis direction inside the third flow path coupling portion 223.

The first portion 403 extends along a plane perpendicular to the Z-axis direction. This first portion 403 is formed by covering, with the first substrate 221, a recess 224 that opens onto a surface of the second substrate 222 facing the +Z direction. That is, the first substrate 221 defines a portion of the first portion 403. Of course, the first portion 403 may be formed by providing a recess in the first substrate 221 and covering this recess with the second substrate 222, or by providing recesses in both the first substrate 221 and the second substrate 222 and overlapping the two recesses. In the present embodiment, the first portion 403 extends along the Y-axis direction and communicates with the second portion 404 at one end in the Y-axis direction.

The second flow path portion 402 and the first flow path portion 401 are liquid-tightly coupled through the seal member 230. The seal member 230 is disposed between the tip surface of the third flow path coupling portion 223 facing in the −Z direction and the surface of the first flow path member 210 facing in the +Z direction. The seal member 230 is made of a material that has liquid resistance to the ink and the like used in the liquid ejecting head 2 and is elastically deformable, such as rubber or elastomer. The seal member 230 is provided with a communication flow path 405 penetrating in the Z-axis direction, and the first flow path portion 401 and the second flow path portion 402 communicate with each other through the communication flow path 405. That is, the flow path 400, which is a supply flow path of the flow path member 200, includes the first flow path portion 401, the second flow path portion 402, and the communication flow path 405.

In addition, the first substrate 221, which is a portion of the flow path member 200 and defines the second flow path portion 402, has a first flow path coupling port 225 that penetrates in the −Z direction from a surface F facing the +Z direction and communicates the first portion 403 with the outside of the second flow path member 220. When viewed in the Z-axis direction, the inner peripheral edge of the first flow path coupling port 225 is larger than the outer peripheral edge of the first flow path coupling portion 43. In other words, the inner diameter of the first flow path coupling port 225 is slightly larger than the outer diameter of the first flow path coupling portion 43. In addition, the first flow path coupling port 225 has a countersunk portion 225a at the end portion in the −Z direction, the inner diameter of which is larger than that of the other region. Note that it is sufficient that at least a portion of the first flow path coupling port 225 is defined in the first substrate 221, and a portion of the first flow path coupling port 225 may be formed in another member. In other words, the first substrate 221 only needs to define at least a portion of the first flow path coupling port 225.

The first flow path coupling portion 43 of the head chip 8 is inserted into this first flow path coupling port 225, and the inner peripheral surface of the first flow path coupling port 225 and the outer peripheral surface of the first flow path coupling portion 43 are bonded together with the adhesive 201, thereby liquid-tightly coupling the coupling flow path 43a of the head chip 8 and the second flow path portion 402. In other words, the head chip 8 and the flow path member 200 are fixed to each other by bonding the surfaces of the head chip 8 and the flow path member 200 that face each other in a direction perpendicular to the Z-axis direction with the adhesive 201. In the present embodiment, the first flow path coupling portion 43 is disposed at a position where a tip 43b thereof protrudes from the first flow path coupling port 225 into the inside of the first portion 403. Specifically, the tip 43b of the first flow path coupling portion 43 is located further in the −Z direction than a bottom surface BS of the first portion 403, that is, the surface of the second substrate 222 facing the −Z direction. The bottom surface BS of the first portion 403 refers to the portion of the surface of the first portion 403 facing the −Z direction that is located furthest in the −Z direction. In other words, the surface of the first portion 403 facing the −Z direction may be a curved surface or may have a shape in which a portion thereof is recessed. In the present embodiment, the bottom surface BS of the first portion 403 is a flat surface along the XY plane defined by the X-axis and the Y-axis. Then, with the first flow path coupling portion 43 inserted into the first flow path coupling port 225, the adhesive 201 is poured from the −Z direction opening of the countersunk portion 225a of the first flow path coupling port 225, and is disposed within the countersunk portion 225a and in a portion of the countersunk portion 225a side within the first flow path coupling port 225. By providing the countersunk portion 225a in this manner, the adhesive 201 can be easily applied inside the first flow path coupling port 225 and can be disposed between the inner peripheral surface of the first flow path coupling port 225 and the outer peripheral surface of the first flow path coupling portion 43. Incidentally, the second flow path member 220 may be formed by bonding the first substrate 221 and the first flow path coupling portion 43 of the head chip 8 with the adhesive 201 and then fixing the first substrate 221 and the second substrate 222 together. In other words, by constructing the second flow path member 220 from the first substrate 221 and the second substrate 222 stacked in the −Z direction, the first substrate 221 and the head chip 8 can be bonded together with adhesive 201, and then the second flow path member 220 can be assembled. Therefore, the first substrate 221 and the head chip 8 can be easily bonded together with the adhesive 201. The method of fixing the first substrate 221 and the second substrate 222 is not particularly limited, and examples of the method include bonding with an adhesive, welding, fixing with screws, fixing by clamping the first substrate 221 and the second substrate 222 together with a clamp, and the like. In addition, when the first substrate 221 and the second substrate 222 are fixed with screws or clamps, a seal member or the like may be provided between the first substrate 221 and the second substrate 222 to ensure a liquid-tight coupling so that ink does not leak between the first substrate 221 and the second substrate 222. The first substrate 221 and the second substrate 222 are preferably bonded together with an adhesive. This eliminates the need for a seal member or the like between the first substrate 221 and the second substrate 222, the number of components can be reduced, and the cost can be reduced.

Note that the adhesive 201 that bonds the head chip 8 and the flow path member 200 together is not interposed between the head chip 8 and the flow path member 200 in the Z-axis direction. Here, “the adhesive is not interposed between the head chip 8 and the flow path member 200 in the Z-axis direction” means that the adhesive 201 is not disposed to couple surfaces of the head chip 8 and the flow path member 200 that face each other in the Z-axis direction. This is because when the adhesive 201 is disposed to couple surfaces that face each other in the Z-axis direction, a shrinkage stress will be applied in the Z-axis direction as the adhesive 201 cures, causing the head chip 8 to move in a direction approaching the flow path member 200 in the Z-axis direction. Therefore, even when the adhesive 201 adheres to either one of the two surfaces of the flow path member 200 and the head chip 8 that face each other in the Z-axis direction, the application of the shrinkage stress in the Z-axis direction can be inhibited. In other words, “the adhesive is not interposed between the head chip 8 and the flow path member 200 in the Z-axis direction” includes the adhesive 201 adhering to either one of the two surfaces of the head chip 8 and the flow path member 200 that face each other in the Z-axis direction.

The adhesive 201 that liquid-tightly couples the coupling flow path 43a of the head chip 8 and the flow path 400 of the flow path member 200 is preferably a thermosetting adhesive with high liquid resistance, since it comes into contact with the liquid flowing within the flow path. A thermosetting adhesive is an adhesive that cures when heated to, for example, 60° C. or higher. Moreover, a thermosetting adhesive is an adhesive that mainly contains a thermosetting resin. Examples of the thermosetting resin used as the adhesive 201 include an epoxy resin, a phenol resin, a urea resin, a melamine resin, an alkyd resin, an unsaturated polyester resin, and a diallyl phthalate resin. These may be used alone or in combination of two or more kinds in the form of a copolymer or blend. The thermosetting resin may contain a fiber base material such as glass fiber, and may contain a filler such as silica powder. In the present embodiment, a thermosetting adhesive made of an epoxy-based adhesive having particularly high liquid resistance is used as the adhesive 201. Incidentally, silicone-based adhesives that mainly contain a silicone resin and urethane-based adhesives that mainly contain a urethane resin are not included in the thermosetting adhesives of the present disclosure because they cure even at room temperature. The adhesive 201 is not limited to a thermosetting adhesive, but may be an ultraviolet-curing adhesive.

In addition, the first substrate 221 has a plurality of legs 226 that protrude in the +Z direction from the surface F facing the +Z direction. The legs 226 come into contact with the surface of the holder 240 facing in the −Z direction, so that the second flow path member 220 is supported on the surface of the holder 240 facing in the −Z direction.

The holder 240 has a first recess 241 that opens to a surface facing the +Z direction. The fixing plate 260 is fixed to the end surface of the holder 240 in the +Z direction, so that an accommodation space 242 is defined inside by the first recess 241 and the fixing plate 260. The head chip 8 is accommodated in this accommodation space 242. In the present embodiment, two head chips 8 are accommodated in one accommodation space 242. Of course, the number of head chips 8 held by the liquid ejecting head 2 is not particularly limited thereto, and may be one, or may be three or more. Further, in the present embodiment, the two head chips 8 are arranged side by side in the Y-axis direction to be at the same position in the X-axis direction. It is needless to say that the disposition of the plurality of head chips 8 is not particularly limited thereto, and may be disposed in a staggered pattern along the X-axis direction, for example. In addition, in the present embodiment, two head chips 8 are disposed in one accommodation space 242, but this is not particularly limited thereto, and the accommodation space 242 may be independent for each head chip 8, or the accommodation space 242 may be independently provided for each head chip group composed of a plurality of head chips 8.

The fixing plate 260 is made of a metal plate such as stainless steel, and has a size sufficient to close the opening of the first recess 241 of the holder 240. The fixing plate 260 defines the accommodation space 242 in the first recess 241 of the holder 240. The two head chips 8 have their surfaces facing the +Z direction, specifically, their fixed substrates 47, fixed to a fixing plate 260 with an adhesive or the like. Furthermore, the fixing plate 260 is provided with an exposure opening portion 261 that exposes the nozzles 21 of the head chip 8 in the +Z direction. The exposure opening portion 261 is provided independently for each head chip 8. Ink is ejected in the form of droplets from the nozzle 21 exposed from the exposure opening portion 261 in the +Z direction.

The thickness of the fixing plate 260 in the Z-axis direction is 300 μm or less, preferably 200 μm or less, and more preferably 100 μm or less. By reducing the thickness of the fixing plate 260 in the Z-axis direction, the distance between the nozzle surface 20a of the head chip 8 and the medium S (the so-called paper gap) can be shortened, thereby improving the landing accuracy of the droplets ejected from the head chip 8 on the medium S.

Moreover, it is preferable that the thickness of the fixing plate 260 in the Z-axis direction is 60 μm or more. When the thickness of the fixing plate 260 in the Z-axis direction is too thin, each member of the liquid ejecting head 2 will be easily deformed due to the stress, collision with the medium S, or the like. Therefore, by making the thickness of the fixing plate 260 60 μm or more, deformation of the fixing plate 260 can be inhibited.

A gap 243 is formed between the surface of the head chip 8 fixed to the fixing plate 260 facing the −Z direction and the bottom surface of the first recess 241 of the holder 240 facing the +Z direction. In other words, the bottom surface of the first recess 241 of the holder 240, which faces each other in the Z-axis direction, and the surface of the head chip 8 facing the −Z direction are not bonded together with an adhesive. A gap 244 is also formed between the peripheral wall that forms the first recess 241 of the holder 240 and the head chip 8. In other words, the holder 240 and the inner peripheral surface of the first recess 241 are not bonded together with an adhesive.

Further, a flow path insertion hole 245 and a first wiring insertion hole 246 penetrating the holder 240 are provided in the bottom surface of the first recess 241 of the holder 240. The flow path insertion holes 245 are provided for inserting the first flow path coupling portions 43 of the head chips 8, and two flow path insertion holes 245 are provided for each head chip 8, for a total of four. The first flow path coupling portion 43 of the head chip 8 is led out in the −Z direction relative to the holder 240 through the flow path insertion hole 245, and is bonded to the second flow path member 220 with the adhesive 201 at a position in the −Z direction relative to the holder 240, as described above. The first wiring insertion holes 246 are provided for the inserting wiring substrate 110 of each head chip 8, and one first wiring insertion hole 246 is provided for each head chip 8, for a total of two. Further, a second wiring insertion hole 227 that communicates with the first wiring insertion hole 246 is provided penetrating the second flow path member 220 in the Z-axis direction. The wiring substrate 110 of the head chip 8 is led out to the surface side facing the −Z direction of the second flow path member 220 through the first wiring insertion hole 246 and the second wiring insertion hole 227.

In addition, in the Z-axis direction, a relay substrate 250 to which the wiring substrates 110 of the plurality of head chips 8 are commonly coupled is provided between the seal member 230 and the first flow path member 210. The relay substrate 250 is made of a hard, rigid substrate with no flexibility, and has wiring, electronic components, and the like (not shown) mounted thereon. In the present embodiment, a connector 251 to which an external wiring is coupled is illustrated as an electronic component. Print signals and the like for controlling the head chips 8 are input from an external wiring through the connector 251 to the relay substrate 250, and are supplied from the relay substrate 250 to each head chip 8. An opening portion 202 for external wiring for inserting an external wiring coupled to the connector 251 is provided on the side wall of the flow path member 200 facing the connector 251. The external wiring is coupled to the connector 251 of the relay substrate 250 provided inside the flow path member 200 through the opening portion 202 for external wiring.

The relay substrate 250 is provided with a third wiring insertion hole 252 for leading out the wiring substrate 110 of the head chip 8 to the surface side facing the −Z direction. The third wiring insertion hole 252 is provided for each head chip 8, for a total of two. The wiring substrate 110 of the head chip 8 is led out to the surface of the relay substrate 250 facing the −Z direction through the third wiring insertion hole 252, and the led out end portion is coupled to the relay substrate 250.

The relay substrate 250 is also provided with a third flow path coupling portion insertion hole 253 that penetrates therethrough in the Z-axis direction. The third flow path coupling portion 223 of the second flow path member 220 is inserted into the −Z direction side of the relay substrate 250 through the third flow path coupling portion insertion hole 253 and is coupled to the communication flow path 405 of the seal member 230.

In such a liquid ejecting head 2, the outer peripheral surface of the first flow path coupling portion 43 of the head chip facing each other in a direction orthogonal to the Z-axis direction and the inner peripheral surface of the first flow path coupling port 225 are bonded together with the adhesive 201 to fix the head chip 8 and the flow path member 200. Therefore, it is possible to inhibit the shrinkage stress caused by the adhesive 201 curing from acting on the head chip 8 in the Z-axis direction. In other words, since the adhesive surface that bonds the head chip 8 and the flow path member 200 with the adhesive 201 is a surface along the Z-axis direction, even when the adhesive 201 cures and shrinks, force is unlikely to be generated in the direction along the Z-axis direction. Incidentally, when the two surfaces of the head chip 8 and the flow path member 200 that face each other in the Z-axis direction are bonded together with an adhesive, the curing and shrinkage of the adhesive will cause the head chip 8 to move closer to the flow path member 200, resulting in a dent in the fixing plate 260. In particular, since the gap 243 is formed between the surface facing the −Z direction of the head chip 8 fixed to the fixing plate 260 as in the present embodiment and the bottom surface facing the +Z direction of the first recess 241 of the holder 240, the head chip 8 can easily move in the −Z direction relative to the flow path member 200. In particular, when a thermosetting adhesive, particularly an epoxy-based adhesive, is used as the adhesive 201, it does not exhibit elasticity after curing, and therefore the stress of curing and shrinkage cannot be alleviated by deformation due to the elasticity of the adhesive after curing, and the head chip is likely to move due to curing and shrinkage. Incidentally, “not exhibiting elasticity” means that the Young's modulus is 1 GPa or more. For example, an epoxy-based adhesive has a Young's modulus of 2 GPa or more after curing. Note that the epoxy-based adhesive as the ultraviolet-curing adhesive also has a similar Young's modulus. Therefore, even when an ultraviolet-curing adhesive is used as the adhesive 201, the head chip 8 is likely to move due to curing and shrinkage of the adhesive in the same manner. Of course, ultraviolet-curing adhesives other than epoxy-based adhesives are also likely to move in the same manner when they have a Young's modulus of 1 GPa or more. In this way, as the head chip 8 moves closer to the holder 240 due to the curing and shrinkage of the adhesive 201, deformation such as dents occurs in the fixing plate 260, the distance between the nozzle surface 20a and the medium S (the so-called paper gap) from increasing, capping problems caused by the cap covering the nozzle surface 20a, and inclination of the ejection direction can be inhibited. Incidentally, examples of caps that cover the nozzle surface 20a include a tight-fitting cap that covers the nozzle surface 20a to prevent the liquid in the nozzles from drying out, and a suction cap that covers the nozzle surface 20a and creates negative pressure inside using a suction pump or the like to suck ink together with air bubbles from the nozzles 21. In the present embodiment, it is possible to inhibit the action of the stress in the Z-axis direction due to the curing and shrinkage of the adhesive 201 on the head chip 8, and therefore it is possible to inhibit the deformation of the fixing plate 260. Therefore, an epoxy-based adhesive that has a large Young's modulus after curing but has excellent liquid resistance can be used as the adhesive 201. This makes it possible to inhibit problems caused by the adhesive 201 being corroded by the liquid, such as poor fixation between the head chip 8 and the flow path member 200 and leakage of liquid due to deterioration of the adhesive 201, and the adhesive 201 becoming foreign matter due to its falling off. Of course, as the adhesive 201, an adhesive such as a urethane-based adhesive, a silicone-based adhesive, or the like may be used. The Young's modulus of urethane-based adhesives and silicone-based adhesives after curing is several M Pa to several tens of M Pa, which is lower than that of thermosetting adhesives and ultraviolet-curing adhesives. Therefore, even when the two surfaces of the head chip 8 and the flow path member 200 that face each other in the Z-axis direction are bonded together with a urethane-based adhesive or a silicone-based adhesive, and the stress in the Z-axis direction acts on the head chip 8 due to the curing and shrinkage of the adhesive, the adhesive itself will deform, making it difficult for the head chip 8 to move along the Z-axis direction and preventing the fixing plate 260 from being dented.

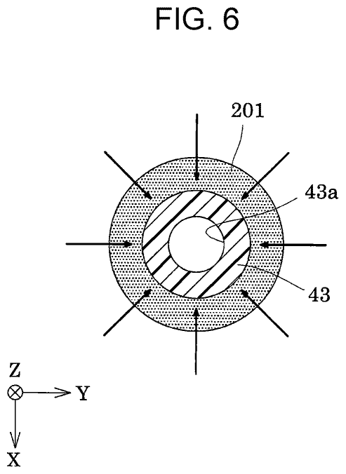

In addition, in the present embodiment, stresses due to the curing and shrinkage of the adhesive 201 are applied from all directions around the outer periphery of the first flow path coupling portion 43 within the XY plane defined by the X-axis and the Y-axis, as shown in FIG. 6, and therefore cancel each other out. In particular, by forming the first flow path coupling portion 43 in a circular tube shape, stresses due to curing and shrinkage of the adhesive 201 act from all directions around the outer periphery, and are more likely to be cancelled out by each other.

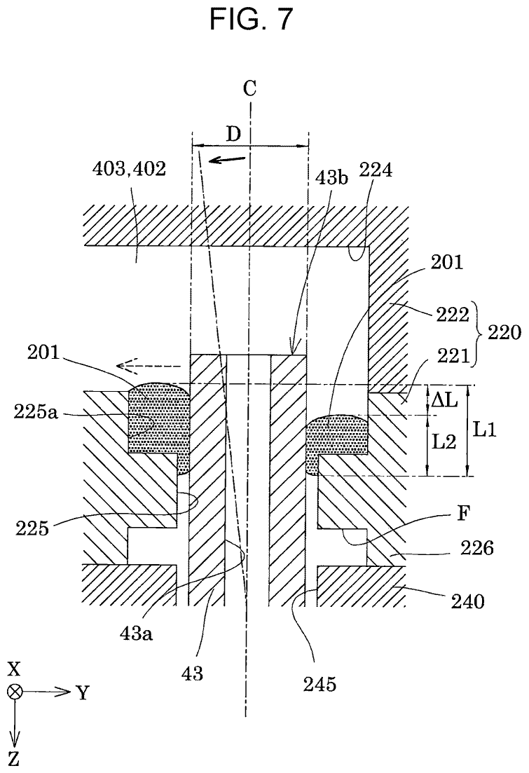

Here, the inclination of the head chip 8 with respect to the Z-axis direction caused by the variation in the height of the adhesive 201 will be described with reference to FIG. 7. FIG. 7 is a cross-sectional view of a main portion for describing the variation in the height of the adhesive 201.

As shown in FIG. 7, when a variation ΔL occurs between a dimension L1 and a dimension L2 in the Z-axis direction of the adhesive 201 in the portion interposed between the outer peripheral surface of the first flow path coupling portion 43 and the inner peripheral surface of the first flow path coupling port 225, the adhesive 201 in the portion of ΔL, that is, the adhesive 201 on the dimension L1 side, will shrink, increasing the force pulling the first flow path coupling portion 43 in the direction indicated by the broken arrow in FIG. 7. In other words, the stress caused by the curing and shrinkage of the adhesive 201 is not cancelled out by the variation ΔL between the dimension L1 and the dimension L2 of the adhesive 201 and acts as a stress on the first flow path coupling portion 43. Since the head chip 8 is fixed to the fixing plate 260, when the stress acting on the first flow path coupling portion 43 becomes large, the head chip 8 tilts in a direction in which the central axis C of first flow path coupling portion 43 is inclined relative to the Z-axis direction, with the portion fixed to the fixing plate 260 as the center, as shown by the solid arrow. When the head chip 8 is tilted in a direction inclined with respect to the Z-axis direction in this manner, there is a concern that a recess will be formed in the fixing plate 260. Therefore, by reducing the variation ΔL, the force of the adhesive 201 causing the first flow path coupling portion 43 to tilt can be suppressed. Therefore, it is preferable that the dimension L2 of the adhesive 201 in the Z-axis direction is equal to or greater than the variation ΔL of the adhesive 201 (L2≥ΔL), it is more preferable that the dimension L2 is greater than the variation ΔL (L2>ΔL), and it is even more preferable that the dimension L2 is greater than twice the variation ΔL (L2>ΔL×2). In addition, the force of the adhesive 201 to tilt the first flow path coupling portion 43 may be suppressed by making the dimension L2 of the adhesive 201 in the Z-axis direction relatively large. In this manner, it is preferable that the dimension L2 in the Z-axis direction of the adhesive 201 for suppressing the force causing the first flow path coupling portion 43 to tilt is equal to or greater than the diameter D of the first flow path coupling portion 43 (L2≥ D), it is more preferable that the dimension L2 is greater than the diameter D (L2>D), and it is even more preferable that the dimension L2 is greater than twice the diameter D (L2>D×2). In this way, by setting the dimension L2 of the adhesive 201 within the above range, it is possible to inhibit the inclination of the head chip 8 in the Z-axis direction due to a stress caused by the curing and shrinkage of the adhesive 201, and thus it is possible to inhibit the occurrence of deformation such as a dent in the fixing plate 260. In addition, the above dimension L1 may be regarded as the maximum dimension in the Z-axis direction of the adhesive 201 in the portion interposed between the outer peripheral surface of the first flow path coupling portion 43 and the inner peripheral surface of the first flow path coupling port 225, and the above dimension L2 may be regarded as the minimum dimension in the Z-axis direction of the adhesive 201 in the interposed portion.

In the present embodiment, the two surfaces of the flow path member 200 and the head chip 8 that face each other in the Z-axis direction are not bonded together with the adhesive 201, but the present disclosure is not particularly limited thereto. For example, two surfaces of the flow path member 200 and the head chip 8 that face each other in the Z-axis direction may be bonded together with an adhesive. For example, in order to temporarily fix the holder 240 and the head chip 8, the bottom surface of the first recess 241 and the surface of the case member 40 facing the −Z direction may be bonded together with an ultraviolet-curing adhesive. However, it is preferable that the thickness d1 of the adhesive 201 between the outer peripheral surface of the first flow path coupling portion 43 and the inner peripheral surface of the first flow path coupling port 225 is greater than the thickness d2 of the adhesive bonding two surfaces facing each other in the Z-axis direction (d1>d2), and it is more preferable that the thickness d1 is equal to or greater than five times the thickness d2 (d1≥d2×5). The thicknesses d1 and d2 of the adhesive mentioned here are the thicknesses after curing. In other words, the thickness d1 corresponds to the dimension of the gap between the outer peripheral surface of the first flow path coupling portion 43 and the inner peripheral surface of the first flow path coupling port 225, with the adhesive 201 interposed therebetween, and the thickness d2 corresponds to the gap between the two surfaces of the flow path member 200 and the head chip 8 that face each other in the Z-axis direction, with the adhesive interposed therebetween. In this way, by making the thickness d1 of the adhesive 201 greater than the thickness d2 of the adhesive bonding two surfaces facing each other in the Z-axis direction, and more preferably making it five times or greater the thickness d2, it is possible to inhibit the movement of the head chip 8 in the Z-axis direction relative to the flow path member 200 due to the stress caused by the curing and shrinkage of the adhesive bonding two surfaces facing each other in the Z-axis direction.

In the present embodiment, the tip 43b of the first flow path coupling portion 43 of the head chip 8 is provided to protrude into the first portion 403. Therefore, the adhesive 201 that bonds the outer peripheral surface of the first flow path coupling portion 43 and the inner peripheral surface of the first flow path coupling port 225 is less likely to adhere to the tip surface of the first flow path coupling portion 43, and the opening of the coupling flow path 43a at the tip surface of the first flow path coupling portion 43 can be inhibited from being blocked by the adhesive 201. Therefore, poor ink supply caused by the opening of the coupling flow path 43a being covered with the adhesive 201 can be inhibited.

In the present embodiment, the +Z direction is an example of a “first direction”, and the −Z direction is an example of a “second direction”. Moreover, the flow path member 200 is an example of a “flow path structure”.

In addition, one of the two head chips 8 is an example of a “first head chip”, the plurality of nozzles 21 constituting one of the two nozzle rows of the first head chip are an example of a “first nozzle”, the common liquid chamber 100 communicating with the plurality of first nozzles is an example of a “first common liquid chamber”, the plurality of nozzles 21 constituting the other of the two nozzle rows are an example of a “third nozzle”, and the common liquid chamber 100 communicating with the plurality of third nozzles is an example of a “third common liquid chamber”.

In addition, one of the two first flow path coupling portions 43 of the first head chip that communicates with the first common liquid chamber is an example of a “first flow path pipe”, and the coupling flow path 43a provided inside this first flow path pipe is an example of a “first coupling flow path”. The other one communicating with the third common liquid chamber is an example of a “third flow path pipe”, and the coupling flow path 43a provided inside the third flow path pipe is an example of a “third coupling flow path”.

In addition, the first flow path coupling port 225 into which the first flow path coupling portion 43, which is the first flow path pipe of the first head chip, is inserted is an example of a “first opening”, the adhesive 201 that bonds the first flow path coupling portion 43 and the first flow path coupling port 225 is an example of a “first adhesive”, and the flow path 400 communicating with this first flow path coupling port 225 is an example of a “first flow path”.

Moreover, one of the two exposure opening portions 261 of the fixing plate 260 that corresponds to the first nozzle of the first head chip is an example of a “first exposure opening portion”.

In addition, the first flow path coupling port 225 into which the first flow path coupling portion 43, which is the third flow path pipe, is inserted is an example of a “third opening”, the adhesive 201 that bonds the first flow path coupling portion 43 and the first flow path coupling port 225 is an example of a “third adhesive”, and the flow path 400 communicating with this first flow path coupling port 225 is an example of a “third flow path”.

In addition, the other of the two head chips 8 is an example of a “second head chip”, the plurality of nozzles 21 of the second head chip are an example of a “second nozzle”, the common liquid chamber 100 communicating with the plurality of nozzles 21 of the second head chip is an example of a “second common liquid chamber”, and the first flow path coupling portion 43 of the second head chip is an example of a “second flow path pipe”. In addition, the first flow path coupling port 225 into which the first flow path coupling portion 43, which is the second flow path pipe of the second head chip, is inserted is an example of a “second opening”, the adhesive 201 that bonds the first flow path coupling portion 43 and the first flow path coupling port 225 is an example of a “second adhesive”, and the flow path 400 communicating with this first flow path coupling port 225 is an example of a “second flow path”. As described above, when the same type of ink is ejected from a plurality of nozzle rows, the flow path 400 may branch midway. In other words, the “first flow path” may be the same flow path as the “second flow path”, and the “first flow path” may be the same flow path as the “third flow path”.

Moreover, the other of the two exposure opening portions 261 of the fixing plate 260 that corresponds to the second nozzle of the second head chip is an example of a “second exposure opening portion”.

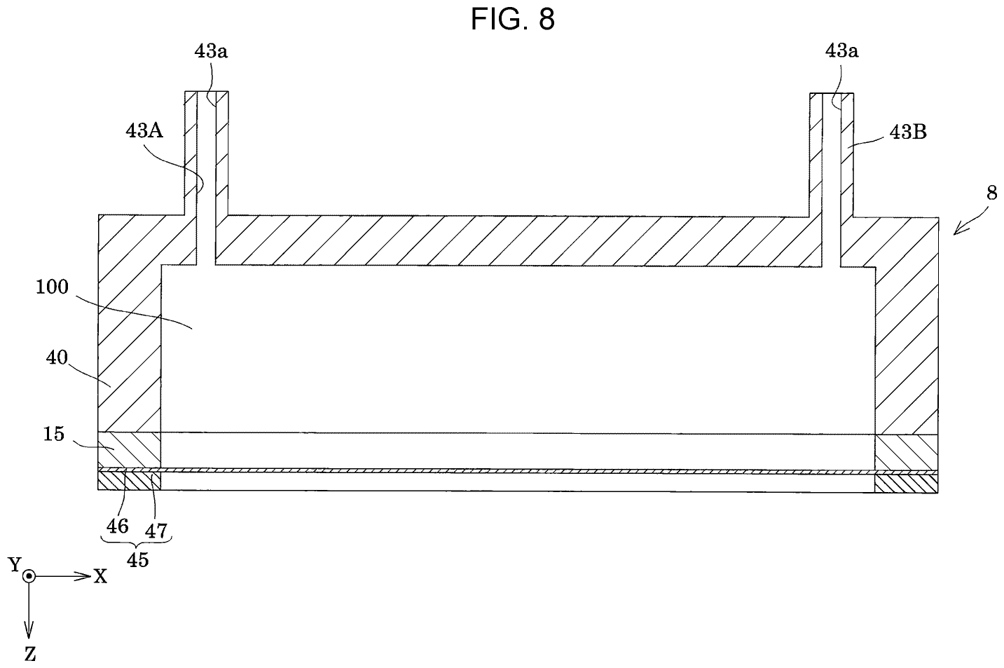

In the present embodiment, only one first flow path coupling portion 43 having a coupling flow path 43a communicating with one common liquid chamber 100 is provided, but the present disclosure is not particularly limited thereto. Here, a modification example of the head chip 8 is shown in FIG. 8. FIG. 8 is a cross-sectional view taken along the X-axis direction, showing a modification example of the head chip 8. As shown in FIG. 8, the common liquid chamber 100 of the head chip 8 communicates with two coupling flow paths 43a. That is, the case member 40 is provided with two first flow path coupling portions 43A and 43B, each having a coupling flow path 43a provided therein for one common liquid chamber 100. In such a head chip 8, ink is supplied to the common liquid chamber 100 from the coupling flow path 43a of the first flow path coupling portion 43A, and ink that is not ejected from the nozzle 21 (see FIG. 5) communicating with the common liquid chamber 100 is discharged to the outside from the coupling flow path 43a of the first flow path coupling portion 43B, so-called ink circulation is performed. Of course, the circulation of ink in the head chip 8 is not limited to circulation within the common liquid chamber 100, but the head chip 8 may be provided with a supply side common liquid chamber that supplies ink to individual flow paths including the pressure chamber 12, and a recovery side common liquid chamber that recovers ink that is not ejected from the nozzle 21 from the individual flow paths, and ink may be circulated between the supply side common liquid chamber and the recovery side common liquid chamber. In this case, one of the common liquid chambers 100 of the head chip 8 is a supply side common liquid chamber, and the other of the common liquid chambers 100 is a recovery side common liquid chamber, the first flow path coupling portion communicating with the supply side common liquid chamber corresponds to the first flow path coupling portion 43A, and the first flow path coupling portion communicating with the recovery side common liquid chamber corresponds to the first flow path coupling portion 43B.

Although not specifically shown, the flow path member 200 is provided with a flow path 400 serving as a supply flow path for supplying ink to the common liquid chamber 100, which is provided in correspondence with the first flow path coupling portion 43A, and a flow path 400 serving as a recovery flow path for discharging ink from the liquid ejecting head 2 to the outside, which is provided in correspondence with the first flow path coupling portion 43B, which are provided independently of each other, and the first flow path coupling portions 43A and 43B and the flow path member 200 may be bonded together with an adhesive 201 in a configuration similar to that of the first embodiment described above.

In such a configuration, the flow path 400 corresponding to the first flow path coupling portion 43A is an example of a “first flow path”, and the flow path 400 corresponding to the first flow path coupling portion 43B is an example of a “third flow path”.

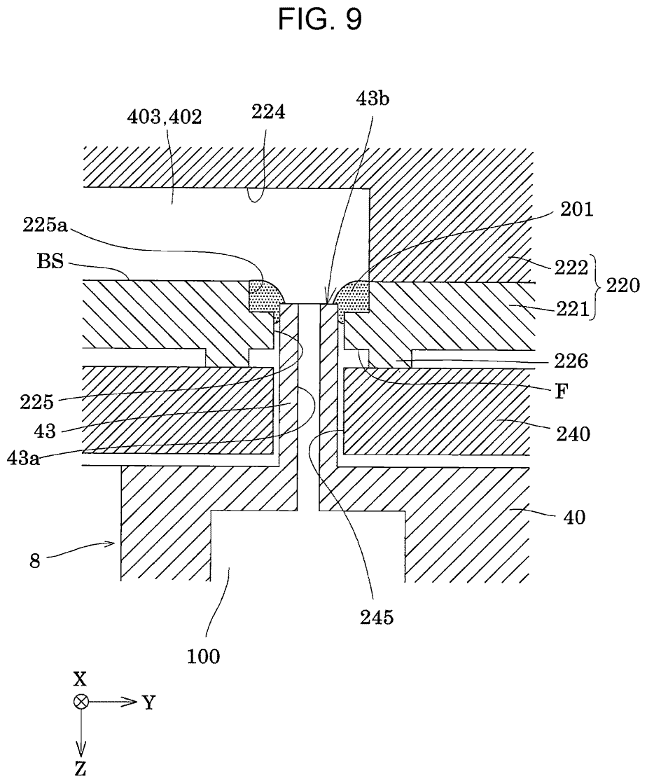

In addition, in the present embodiment, the first flow path coupling portion 43 of the head chip 8 is illustrated as having its tip 43b disposed to protrude in the −Z direction from the bottom surface of the first portion 403, but the present disclosure is not particularly limited thereto. Here, FIG. 9 shows a modification example of the liquid ejecting head 2 according to the first embodiment. FIG. 9 is an enlarged cross-sectional view of a main portion of a modification example of the liquid ejecting head 2 according to the first embodiment.

As shown in FIG. 9, the first flow path coupling portion 43 of the head chip 8 has its tip 43b located in a position that does not protrude further in the −Z direction than the bottom surface BS of the first portion 403, that is, located further in the +Z direction than the bottom surface BS. In other words, a portion of the first flow path coupling port 225 constitutes a portion of the second flow path portion 402. In addition, the tip 43b of the first flow path coupling portion 43 is preferably disposed at a position facing the countersunk portion 225a when viewed in a direction along the XY plane. Accordingly, when the adhesive 201 is applied from the countersunk portion 225a, the adhesive 201 is unlikely to adhere to the tip 43b of the first flow path coupling portion 43, and it is possible to inhibit the adhesive 201 from closing the opening of the coupling flow path 43a. In this way, by disposing the tip 43b of the first flow path coupling portion 43 so that it does not protrude further in the −Z direction than the bottom surface of the first portion 403, it is possible to inhibit regions where the ink flow stagnates, and to inhibit air bubbles captured in the region where the ink flow stagnates from growing and flowing toward the nozzle 21 at an unexpected timing, resulting in poor ink droplet ejection.

In addition, the tip 43b of the first flow path coupling portion 43 may be at the same position in the Z-axis direction as the bottom surface BS of the first portion 403.

### Second Embodiment

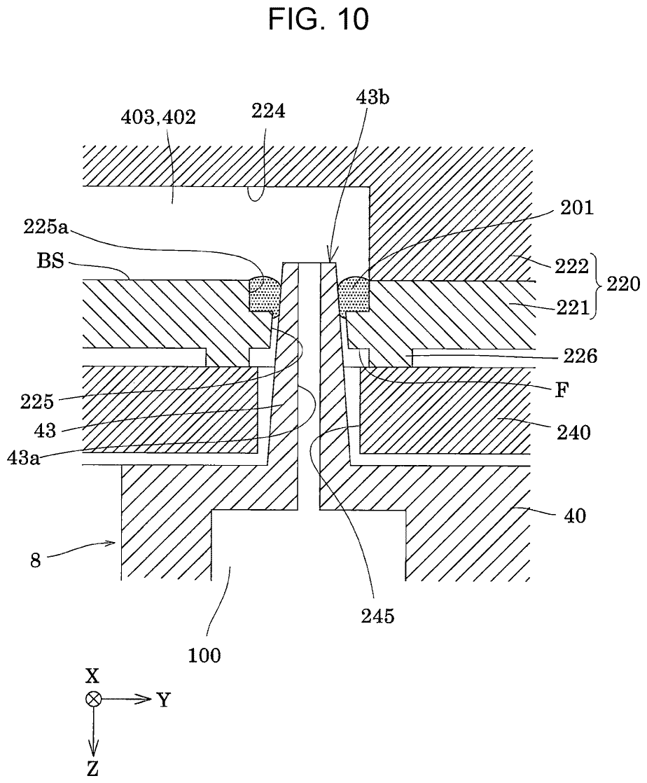

FIG. 10 is an enlarged cross-sectional view of a main portion of a liquid ejecting head 2 according to a second embodiment of the present disclosure. In addition, the same reference numerals are used for the same members as those in the above-described embodiment, and a duplicated description will be omitted.

As shown in FIG. 10, the first flow path coupling portion 43 of the head chip 8 is a tapered surface whose outer peripheral surface is tilted in the Z-axis direction so that the outer diameter gradually decreases in the −Z direction. Therefore, the outer diameter of the tip 43b of the first flow path coupling portion 43 is the smallest.

Further, the inner peripheral surface of the first flow path coupling port 225 is a tapered surface whose inner diameter gradually increases in the +Z direction. Therefore, the opening at the end portion of the first flow path coupling port 225 in the +Z direction is the largest.

In this configuration, since the opening at the end portion of the first flow path coupling port 225 in the +Z direction is the largest, and the outer diameter of the tip 43b of the first flow path coupling portion 43 is the smallest, the first flow path coupling portion 43 can be easily inserted into the first flow path coupling port 225, and the both tapered surfaces can be used as guides to facilitate the insertion. The angle between the both tapered surfaces with respect to the Z-axis direction is preferably within 5 degrees, more preferably within 3 degrees, and even more preferably within 2 degrees. By setting the inclination angle of the both tapered surfaces within the above range, the curing and shrinkage in the Z-axis direction when the tapered surfaces are bonded together with the adhesive 201 is reduced, and thus it is possible to inhibit the movement of the head chip 8 in the Z-axis direction relative to the flow path member 200.

### Third Embodiment

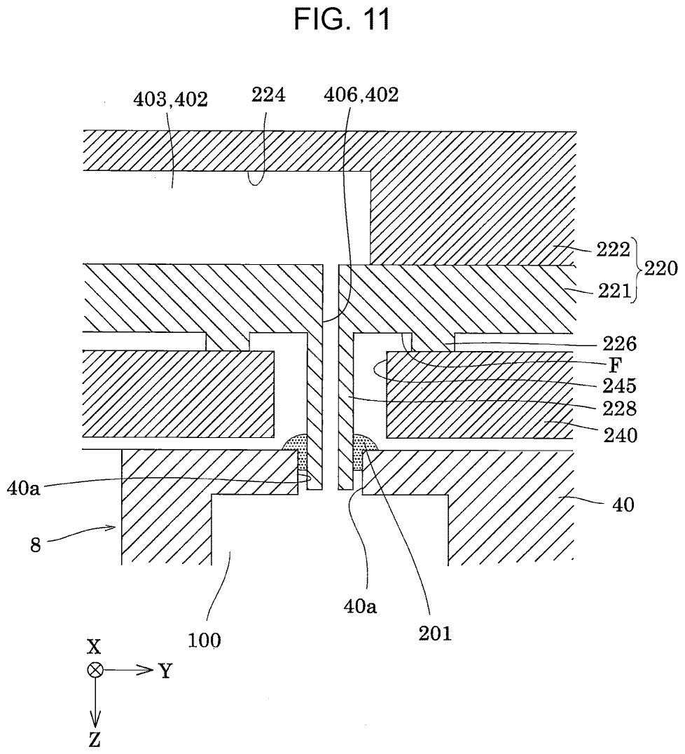

FIG. 11 is an enlarged cross-sectional view of a main portion of a liquid ejecting head 2 according to a third embodiment of the present disclosure. In addition, the same reference numerals are used for the same members as those in the above-described embodiment, and a duplicated description will be omitted.

The liquid ejecting head 2 according to the third embodiment includes a head chip 8, a flow path member 200, a relay substrate 250, and a fixing plate 260 (see FIGS. 2 and 3).

As shown in FIG. 11, the flow path member 200 includes a first flow path member 210 and a second flow path member 220. The first flow path member 210 is similar to that in the first embodiment described above, and therefore a duplicated description will be omitted.

The second flow path member 220 has a first substrate 221 and a second substrate 222. The first substrate 221 and the second substrate 222 are stacked in this order in the −Z direction. Further, a fourth flow path coupling portion 228 is provided on a surface F of the first substrate 221 facing the +Z direction, the fourth flow path coupling portion 228 being provided to protrude in a tubular shape toward the +Z direction. In the present embodiment, the fourth flow path coupling portion 228 has a circular outer periphery when viewed in the Z-axis direction, that is, a so-called circular tube shape. The fourth flow path coupling portion 228 has a third portion 406 that communicates with the first portion 403 inside. That is, the second flow path member 220 is provided with a second flow path portion 402 having a first portion 403, a second portion 404 (see FIG. 3), and a third portion 406.

A second flow path coupling port 40a is provided in the case member 40 of the head chip 8. The second flow path coupling port 40a has one end communicating with the common liquid chamber 100 and the other end opening to the surface of the case member 40 facing the −Z direction. The inner diameter of the second flow path coupling port 40a is slightly larger than the outer diameter of the fourth flow path coupling portion 228, and the fourth flow path coupling portion 228 is inserted into the second flow path coupling port 40a. The outer peripheral surface of the fourth flow path coupling portion 228 and the inner peripheral surface of the second flow path coupling port 40a are bonded together with an adhesive 201. The adhesive 201 used is the same as that used in the first embodiment described above.

Even with this configuration, it is possible to inhibit the stress acting on the head chip 8 in the Z-axis direction due to the curing and shrinkage of adhesive 201, and to inhibit the movement of the head chip 8 in the Z-axis direction relative to the flow path member 200. Therefore, it is possible to inhibit the occurrence of a dent in the fixing plate 260 due to the curing and shrinkage of the adhesive 201.

In the present embodiment, the tip of the fourth flow path coupling portion 228 in the +Z direction is located inside the second flow path coupling port 40a and is disposed so as not to protrude into the common liquid chamber 100. Of course, the present disclosure is not limited thereto, and the tip of the fourth flow path coupling portion 228 in the +Z direction may be disposed to protrude into the common liquid chamber 100.

A Iso, similarly to the modification example of the first embodiment described above, the outer peripheral surface of the fourth flow path coupling portion 228 may be a tapered surface provided so that the outer diameter gradually decreases toward the +Z direction, and the inner peripheral surface of the second flow path coupling port 40a may be a tapered surface provided so that the inner diameter gradually increases toward the −Z direction.

In the present embodiment, the +Z direction is an example of a “first direction”, and the −Z direction is an example of a “second direction”. Moreover, the flow path member 200 is an example of a “flow path structure”.

In addition, either or both of the two head chips 8 is an example of a “first head chip”, the nozzle 21 constituting one of the two nozzle rows of the first head chip is an example of a “first nozzle”, and the common liquid chamber 100 communicating with this first nozzle is an example of a “first common liquid chamber”.

In addition, the second flow path coupling port 40a of the first head chip is an example of a “first opening”, the fourth flow path coupling portion 228 corresponding to the first opening is an example of a “first flow path pipe”, and the third portion 406 provided inside this first flow path pipe is an example of a “first coupling flow path”. In addition, the adhesive 201 that bonds the second flow path coupling port 40a and the fourth flow path coupling portion 228 is an example of a “first adhesive”, and the flow path 400 corresponding to the second flow path coupling port 40a is an example of a “first flow path”.

Moreover, one of the two exposure opening portions 261 of the fixing plate 260 that corresponds to the first nozzle of the first head chip is an example of a “first exposure opening portion”.

In addition, the configuration of the fourth flow path coupling portion 228 and the second flow path coupling port 40a of the present embodiment and the configuration of the first flow path coupling portion 43 and the first flow path coupling port 225 of the above-mentioned first embodiment or a modification example thereof can be combined and provided in one liquid ejecting head 2. For example, as shown in FIG. 8, when circulating ink within the head chip 8, the configuration of the third embodiment may be applied to the coupling portion between the flow path 400 that supplies ink from the flow path member 200 to the head chip 8 and the flow path of the head chip 8, and the configuration of the first embodiment or a modification example thereof may be applied to the coupling portion between the flow path 400 that recovers ink from the head chip 8 to the flow path member 200 and the flow path of the head chip 8. Accordingly, it is possible to reduce the region where ink is likely to stagnate at the flow path coupling portion between the head chip 8 and the flow path member 200, and to inhibit air bubbles captured in the region where the ink flow stagnates from growing and flowing toward the nozzle 21 at an unexpected timing, resulting in poor ink droplet ejection.

### OTHER EMBODIMENTS

Although each embodiment of the present disclosure was described above, the basic configuration of the present disclosure is not limited to the above embodiments.

For example, in each of the above-described embodiments, the first portion 403 of the second flow path portion 402 to which the coupling flow path 43a of the first flow path coupling portion 43 is coupled is illustrated as extending along the XY plane, but the present disclosure is not particularly limited thereto, and the second flow path portion 402 to which the coupling flow path 43a is coupled may be extended along the Z-axis direction.

In addition, in each of the above-described embodiments, the holder 240 does not have the flow path 400, but the present disclosure is not particularly limited thereto, and a portion of the flow path 400 may be formed in the holder 240.

In each of the above-described embodiments, a thin-film type piezoelectric actuator 300 was used as the drive element for generating a pressure change in the pressure chamber 12, but the present disclosure is not particularly limited thereto, and as the drive element, for example, a thick-film type piezoelectric actuator formed by a method such as adhering a green sheet, a longitudinal vibration type piezoelectric actuator in which piezoelectric material and electrode forming material are alternately stacked to expand and contract in the axial direction, or the like can be used. In addition, as the drive element, for example, an element in which a heating element is disposed in the pressure chamber 12 to eject the droplets from the nozzle 21 by bubbles generated due to the heat of the heating element, or a so-called electrostatic actuator that generates static electricity between a vibration plate and an electrode, deforms the vibration plate by the electrostatic force, and ejects the droplets from the nozzle 21 can be used.

Further, the present disclosure is intended to cover a wide range of liquid ejecting apparatuses equipped with liquid ejecting heads. Examples of the liquid ejecting head include recording heads such as various ink jet recording heads used in an image recording apparatus such as a printer, and coloring material ejecting heads used in the manufacture of color filters in liquid crystal displays and the like. Examples of the liquid ejecting head include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses equipped with these liquid ejecting heads.

### Supplementary Notes

From the above-mentioned exemplary embodiments, the following configurations can be understood, for example.

According to Aspect 1 which is a preferred aspect, there is provided a liquid ejecting head including: a first head chip having a plurality of first nozzles that eject a liquid in a first direction and a first common liquid chamber that communicates with the plurality of first nozzles; a flow path structure having a first flow path that communicates with the first common liquid chamber; a fixing plate that accommodates the first head chip between the fixing plate and the flow path structure by fixing the first head chip to the fixing plate, and has a first exposure opening portion for exposing the plurality of first nozzles; and a first adhesive, in which the first head chip has a first flow path pipe that protrudes in a second direction opposite to the first direction from a surface facing the second direction and that has a first coupling flow path communicating with the first common liquid chamber inside, the flow path structure has a first opening that penetrates a portion of the flow path structure in the second direction from a surface facing the first direction and into which the first flow path pipe is inserted, and the first flow path and the first coupling flow path are liquid-tightly coupled with the first adhesive disposed between an outer peripheral surface of the first flow path pipe and an inner peripheral surface of the first opening. According to this, the stress caused by the curing and shrinkage of the first adhesive acts in all directions around a first flow path coupling pipe in a plane perpendicular to the first direction when viewed from the first flow path pipe, and the stresses can cancel each other out. Therefore, it is possible to inhibit the movement of the first head chip in the second direction relative to the flow path structure, and to inhibit the occurrence of deformation such as a dent in the fixing plate.

In Aspect 2 which is a specific example of Aspect 1, the first adhesive is not interposed between the first head chip and the flow path structure in the first direction. According to this, since no stress is generated in the first direction due to curing and shrinkage of the adhesive, it is possible to further inhibit movement of the first head chip in the second direction relative to the flow path structure.

In Aspect 3 which is a specific example of Aspect 1, the first flow path includes a first portion extending along a plane perpendicular to the first direction, and a tip of the first flow path pipe protrudes further in the second direction than a bottom surface of the first portion. According to this, when the first adhesive is applied, the first adhesive is unlikely to adhere to the tip of the first flow path pipe, and the first adhesive is unlikely to block a flow path opening of the first flow path pipe.

In Aspect 4 which is a specific example of Aspect 3, the flow path structure includes a first substrate that defines at least a portion of the first opening and a portion of the first portion, and a second substrate that is stacked on the first substrate to define a portion of the first portion. According to this, the flow path coupling between the first substrate and the first head chip can be performed before the second substrate is fixed to the first substrate, thereby improving the ease of assembly.

In Aspect 5 which is a specific example of Aspect 1, each of a first substrate that defines at least a portion of the first opening and the first flow path pipe is a rigid body. According to this, it is possible to inhibit deformation, such as dents, of the fixing plate caused by curing and shrinkage of the first adhesive that bonds the rigid bodies together.

In Aspect 6 which is a specific example of Aspect 1, the liquid ejecting head further includes: a second head chip having a plurality of second nozzles and a second common liquid chamber that communicates with the plurality of second nozzles; and a second adhesive, in which the fixing plate accommodates the second head chip between the fixing plate and the flow path structure by fixing the second head chip to the fixing plate, and has a second exposure opening portion for exposing the plurality of second nozzles, the flow path structure has a second flow path that communicates with the second common liquid chamber, the second head chip has a second flow path pipe that protrudes in the second direction from the surface facing the second direction and that has a second coupling flow path communicating with the second common liquid chamber inside, the flow path structure has a second opening that penetrates a portion of the flow path structure in the second direction from the surface facing the first direction and into which the second flow path pipe is inserted, and the second flow path and the second coupling flow path are liquid-tightly coupled with the second adhesive disposed between an outer peripheral surface of the second flow path pipe and an inner peripheral surface of the second opening. According to this, the stress caused by the curing and shrinkage of the second adhesive acts in all directions around a second flow path coupling pipe in a plane perpendicular to the first direction when viewed from the second flow path pipe, and the stresses can cancel each other out. Therefore, it is possible to inhibit the movement of the second head chip in the second direction relative to the flow path structure, and to inhibit the occurrence of deformation such as a dent in the fixing plate.

In Aspect 7 which is a specific example of Aspect 1, the liquid ejecting head further includes: a third adhesive, in which the flow path structure has a third flow path, the first head chip has a third flow path pipe that protrudes in the second direction from the surface facing the second direction and that has a third coupling flow path communicating with the third common liquid chamber inside, the flow path structure has a third opening that penetrates a portion of the flow path structure in the second direction from the surface facing the first direction and into which the third flow path pipe is inserted, and the third flow path and the third coupling flow path are liquid-tightly coupled with the third adhesive disposed between an outer peripheral surface of the third flow path pipe and an inner peripheral surface of the third opening. According to this, the stress caused by the curing and shrinkage of the third adhesive acts in all directions around a third flow path coupling pipe in a plane perpendicular to the first direction when viewed from the third flow path pipe, and the stresses can cancel each other out. Therefore, it is possible to inhibit the movement of the first head chip in the second direction relative to the flow path structure, and to inhibit the occurrence of deformation such as a dent in the fixing plate.

In Aspect 8 which is a specific example of Aspect 7, the first flow path is a flow path for supplying a liquid to the first common liquid chamber, and the third flow path is a flow path for recovering a liquid that is supplied to the first common liquid chamber and not ejected from the plurality of first nozzles.

In Aspect 9 which is a specific example of Aspect 7, the first head chip has a plurality of third nozzles different from the plurality of first nozzles, and a third common liquid chamber that communicates with the plurality of third nozzles, and the third flow path communicates with the third common liquid chamber.

In Aspect 10 which is a specific example of Aspect 9, the first flow path and the third flow path are independent of each other.

In Aspect 11 which is a specific example of Aspect 1, the first adhesive is a thermosetting adhesive. According to this, when the first adhesive cures at high temperatures, a stress due to a difference in linear expansion between the first adhesive and the object to which the first adhesive is bonded tends to become large; however, the difference in linear expansion of the first adhesive and the stress due to curing and shrinkage can cancel each other out, thereby inhibiting deformation, such as dents, of the fixing plate. Furthermore, by using a thermosetting adhesive as the first adhesive, the liquid resistance of the first adhesive can be improved, and poor fixation due to corrosion by the liquid, leakage of the liquid, and the like can be inhibited.

In Aspect 12 which is a specific example of Aspect 1, the fixing plate has a thickness of 300 μm or less. According to this, by shortening the distance between the medium and the nozzle surface in which the nozzles are open, print quality can be improved.

According to Aspect 13 which is a preferred aspect, there is provided a liquid ejecting head including: a first head chip having a plurality of first nozzles that eject a liquid in a first direction and a first common liquid chamber that communicates with the plurality of first nozzles; a flow path structure having a first flow path that communicates with the first common liquid chamber; a fixing plate that accommodates the first head chip between the fixing plate and the flow path structure by fixing the first head chip to the fixing plate, and has a first exposure opening portion for exposing the plurality of first nozzles; and a first adhesive, in which the flow path structure has a first flow path pipe that protrudes in the first direction from a surface facing the first direction and that has a first coupling flow path which is a portion of the first flow path, inside, the first head chip has a first opening that penetrates a portion of the first head chip in the first direction from a surface facing a second direction opposite to the first direction and into which the first flow path pipe is inserted, and the first common liquid chamber and the first coupling flow path are liquid-tightly coupled with the first adhesive disposed between an outer peripheral surface of the first flow path pipe and an inner peripheral surface of the first opening. According to this, the stress caused by the curing and shrinkage of the first adhesive acts in all directions around a first flow path coupling pipe in a plane perpendicular to the first direction when viewed from the first flow path pipe, and the stresses can cancel each other out. Therefore, it is possible to inhibit the movement of the first head chip in the second direction relative to the flow path structure, and to inhibit the occurrence of deformation such as a dent in the fixing plate.

According to Aspect 14 which is a preferred aspect, there is provided a liquid ejecting apparatus including: the liquid ejecting head according to the above aspect; and a liquid storage portion that stores a liquid to be supplied to the liquid ejecting head. According to this, it is possible to inhibit deformation, such as dents, of the fixing plate, thereby improving print quality and inhibiting problems such as poor capping by the cap member.

What is claimed is:

1. A liquid ejecting head comprising:
a first head chip having first nozzles configured to eject a liquid in a first direction and a first common liquid chamber that communicates with the first nozzles;
a flow path structure having a first flow path that communicates with the first common liquid chamber;
a fixing plate that accommodates the first head chip between the fixing plate and the flow path structure by fixing the first head chip to the fixing plate, and has a first exposure opening portion for exposing the first nozzles; and
a first adhesive, wherein
the first head chip has a first flow path pipe that protrudes in a second direction opposite to the first direction from a surface facing the second direction and that has a first coupling flow path communicating with the first common liquid chamber inside,
the flow path structure has a first opening that penetrates a portion of the flow path structure in the second direction from a surface facing the first direction and into which the first flow path pipe is inserted, and
the first flow path and the first coupling flow path are liquid-tightly coupled with the first adhesive disposed between an outer peripheral surface of the first flow path pipe and an inner peripheral surface of the first opening.

2. The liquid ejecting head according to claim 1, wherein
the first adhesive is not interposed between the first head chip and the flow path structure in the first direction.

3. The liquid ejecting head according to claim 1, wherein
the first flow path includes a first portion extending along a plane perpendicular to the first direction, and
a tip of the first flow path pipe protrudes further in the second direction than a bottom surface of the first portion.

4. The liquid ejecting head according to claim 3, wherein
the flow path structure includes a first substrate that defines at least a portion of the first opening and a portion of the first portion, and a second substrate that is stacked on the first substrate to define a portion of the first portion.

5. The liquid ejecting head according to claim 1, wherein
each of a first substrate that defines at least a portion of the first opening and the first flow path pipe is a rigid body.

6. The liquid ejecting head according to claim 1, further comprising:
a second head chip having second nozzles and a second common liquid chamber that communicates with the second nozzles; and
a second adhesive, wherein
the fixing plate accommodates the second head chip between the fixing plate and the flow path structure by fixing the second head chip to the fixing plate, and has a second exposure opening portion for exposing the second nozzles,
the flow path structure has a second flow path that communicates with the second common liquid chamber,
the second head chip has a second flow path pipe that protrudes in the second direction from the surface facing the second direction and that has a second coupling flow path communicating with the second common liquid chamber inside,
the flow path structure has a second opening that penetrates a portion of the flow path structure in the second direction from the surface facing the first direction and into which the second flow path pipe is inserted, and
the second flow path and the second coupling flow path are liquid-tightly coupled with the second adhesive disposed between an outer peripheral surface of the second flow path pipe and an inner peripheral surface of the second opening.

7. The liquid ejecting head according to claim 1, further comprising:
a third adhesive, wherein
the flow path structure has a third flow path,
the first head chip has a third flow path pipe that protrudes in the second direction from the surface facing the second direction and that has a third coupling flow path communicating with the third common liquid chamber inside,
the flow path structure has a third opening that penetrates a portion of the flow path structure in the second direction from the surface facing the first direction and into which the third flow path pipe is inserted, and
the third flow path and the third coupling flow path are liquid-tightly coupled with the third adhesive disposed between an outer peripheral surface of the third flow path pipe and an inner peripheral surface of the third opening.

8. The liquid ejecting head according to claim 7, wherein
the first flow path is a flow path for supplying a liquid to the first common liquid chamber, and
the third flow path is a flow path for recovering a liquid that is supplied to the first common liquid chamber and not ejected from the first nozzles.

9. The liquid ejecting head according to claim 7, wherein
the first head chip has third nozzles different from the first nozzles, and a third common liquid chamber that communicates with the third nozzles, and
the third flow path communicates with the third common liquid chamber.

10. The liquid ejecting head according to claim 9, wherein
the first flow path and the third flow path are independent of each other.

11. The liquid ejecting head according to claim 1, wherein
the first adhesive is a thermosetting adhesive.

12. The liquid ejecting head according to claim 1, wherein
the fixing plate has a thickness of 300 μm or less.

13. A liquid ejecting head comprising:
a first head chip having first nozzles that eject a liquid in a first direction and a first common liquid chamber that communicates with the first nozzles;
a flow path structure having a first flow path that communicates with the first common liquid chamber;
a fixing plate that accommodates the first head chip between the fixing plate and the flow path structure by fixing the first head chip to the fixing plate, and has a first exposure opening portion for exposing the first nozzles; and
a first adhesive, wherein
the flow path structure has a first flow path pipe that protrudes in the first direction from a surface facing the first direction and that has a first coupling flow path which is a portion of the first flow path, inside,
the first head chip has a first opening that penetrates a portion of the first head chip in the first direction from a surface facing a second direction opposite to the first direction and into which the first flow path pipe is inserted, and
the first common liquid chamber and the first coupling flow path are liquid-tightly coupled with the first adhesive disposed between an outer peripheral surface of the first flow path pipe and an inner peripheral surface of the first opening.

14. A liquid ejecting apparatus comprising:
the liquid ejecting head according to claim 1; and
a liquid storage portion that stores a liquid to be supplied to the liquid ejecting head.

15. A liquid ejecting apparatus comprising:
the liquid ejecting head according to claim 13; and
a liquid storage portion that stores a liquid to be supplied to the liquid ejecting head.
